(19) United States
(12) Patent Application Publication
(10) Pub. No.: US 2005/0042990 A1
(43) Pub. Date: Feb. 24, 2005

(54) Wireless communication unit

(75) Inventor: Terukazu Otsuki, Ikoma-gun (JP)

Correspondence Address: NIXON & VANDERHYE, PC, 1100 N GLEBE ROAD, 8TH FLOOR, ARLINGTON, VA, 22201-4714, US

(73) Assignee: Sharp Kabushiki Kaisha, Osaka (JP)

(21) Appl. No.: 10/911,518

(22) Filed: Aug. 5, 2004

(30) Foreign Application Priority Data
Aug. 20, 2003 (JP) 2003-295891

(51) Int. Cl. H04M 1/00; H04B 1/38

(52) U.S. Cl. 455/90.3; 455/558

(57) ABSTRACT

A wireless communication unit is comprised of a printed wiring board, and conductive and nonconductive casing portions for enclosing the printed wiring board. Formed on the surface of the printed wiring board are an antenna element, a RF circuit block, and a ground land. A ground terminal portion is formed on a metallic shell that forms the conductive casing portion. A pressing portion provided on a synthetic resin shell of the nonconductive casing portion presses against the conductive casing portion so as to keep the ground terminal portion in contact with the ground land.

This non-provisional application claims priority under 35 U.S.C. § 119(a) on Patent Application No. 2003-295891 filed in Japan on Aug. 20, 2003, the entire contents of which are hereby incorporated by reference.

### BACKGROUND OF THE INVENTION

1. Field of the Invention

The present invention relates to a wireless communication unit for performing a short-range radio communication of digital data.

2. Description of the Prior Art

When a wireless LAN (Local Area Network) is configured by using personal computers (PCs), a card-type wireless communication unit, more specifically, a wireless LAN communication card is used. Such examples of the wireless LAN communication unit are found in Japanese Patent Application Laid-Open No. H10-75082 or No. H11-261274. How the wireless LAN communication card is used is shown in FIG. 8. FIG. 8 is a perspective view of a notebook PC. The illustration shows a wireless LAN communication card 10 inserted into a card slot 2 located at a side face of the PC 1.

The wireless LAN communication card 10, that is commercially available, transmits and receives data by using a high-frequency radio wave in the 2.4 GHz or 5 GHz frequency band. A structural example of the wireless LAN communication card 10 is shown in FIG. 9.

FIG. 9 is an exploded perspective view of the wireless LAN communication card 10. Configured as a center piece of the wireless LAN communication card 10 is a rectangular multilayer printed wiring board 11 having surface-mount electronic components mounted on circuit patterns arranged on a surface thereof so as to form a certain electric circuit. Fitted to one end of the printed wiring board 11 is a connector 12 for connecting to a connector placed deep inside of the card slot 2. An antenna element 13 is mounted on the other end of the printed wiring board 11, the end protrudes from the card slot 12 even when the wireless LAN communication card 10 is fully inserted into an end in the card slot 2.

An RF circuit block 14, that is a high-frequency circuit block is formed on a part of a surface of the printed wiring board 11. The RF circuit block 14 is so shielded with an inner shield case 15 that high-frequency noise emanating from the RF circuit block 14 does not affect other circuit portions laid on the printed wiring board 11 such as, for example, a power supply circuit, a baseband digital signal processing circuit, the antenna element 13, and do not exit to outside of the card, and that the RF circuit block 14 itself is not affected by external noise. The inner shield case 15 is made of a conductive material. It is often the case that a surface-treated steel plate such as a tin plate is chosen as the conductive material in view of manufacturing costs and physical strength. The inner shield case 15 is rectangular in plan view. On the surface of the printed wiring board 11 is formed ground lands 16 in such a pattern that each of the ground lands 16 corresponds to each of the four sides of the inner shield case 15.

A casing for enclosing the printed wiring board 11 comprises a conductive casing portion 20 and a nonconductive casing portion 21. The conductive casing portion 20 encloses a portion of the printed wiring board between the connector 12 and the RF circuit block 14. The antenna element 13 is located outside of the conductive casing portion 20.

The conductive casing portion 20 is constructed by joining together of shells 20a and 20b, both of which are made of metal such as a stainless steel plate. This portion is inserted into the card slot 2. The nonconductive casing portion 21 is constructed by joining together of shells 21a and 21b, both of which are made of synthetic resin. This portion protrudes from the card slot 2. The antenna element 13 is enclosed with the nonconductive casing portion 21, hence, transmitting and receiving the radio waves will not be interrupted.

If the frequency band used by the wireless LAN communication card 10 is 2.4 GHz, then, the degree of influences exerted on the surrounding circuit blocks by the high-frequency noise emanating from the RF circuit block 14 is relatively small. In this case, it is possible to use a more inexpensive component than the inner shield case 15 instead. FIGS. 10 and 11 show such alternative structural examples. FIG. 10 is a partial cross sectional view of the wireless LAN communication card 10 and FIG. 11 is a partial perspective view thereof Here, a terminal plate 17 formed by bending a resilient metal plate into an elbow shape is mounted on the ground land 16. When the conductive casing portion 20 is assembled, the terminal plate 17 is brought into contact with an inner surface of the shell 20a by its own resiliency. In this way, the ground land 16 and the conductive casing portion 20 are connected together electrically so that the conductive casing portion 20 achieves electromagnetic shielding.

When a high-frequency circuit block of the wireless communication unit is shielded with an inner shield case, the inner shield case shall be fitted and fixed to the printed wiring board through a partial soldering or second reflow soldering process after surface-mount electronic components are mounted on the printed wiring board and soldered to it through a reflow soldering process.

When the partial soldering is conducted manually, a worker applies solder and performs soldering with naked eyes. This always raises concerns about mistakes during the work.

If the partial soldering process is automated in an attempt to eliminate the human error, a specially-designed robotic appliance is required, resulting in a higher expenditure.

When the second reflow soldering process is used to fix the inner shield case, the entire electronic components are to pass through a reflow oven again. If the number of reflow processes is increased in this way, in addition to the energy costs being increased, the reliability of component mounting will be decreased. And, as to the second reflow soldering process, spots to which the inner shield case is soldered need to be applied with solder paste, that means, the steps of soldering process will not necessarily be reduced.

Moreover, in the wireless communication unit, the high-frequency circuit block, more often than not, is formed by using both sides of the printed wiring board. This will result in repeating the process of fixing the inner shield case, as previously described, for both sides of the printed wiring board. In the structure using the inner shield case, therefore, the assembling cost will be inevitably increased in addition to the component cost.

When the inner shield case is eliminated and the resilient terminal plate is used to connect the printed wiring board and the conductive casing portion together as the examples shown in FIGS. 10 and 11, the component cost will be reduced. However, the cost for mounting the terminal plate is still necessary. In addition, because the terminal plate is to connect the printed wiring board and the conductive casing portion together only partially, the electromagnetic shielding effect within the conductive casing portion is extremely limited. The effect of high-frequency noise to other circuit blocks is unavoidable in a wireless communication unit using the 5 GHz frequency band.

To electromagnetically shield a wider area with a terminal plate, it is necessary to use a wider terminal plate 17a as shown in FIG. 12. In this case, manufacturing cost of the terminal plate will be increased because of its odd shape, and so is its mounting cost since it cannot be mounted by an automated machine.

Instead of a wide terminal plate, a plurality of ordinary terminal plate 17 can be lined up as shown in FIG. 13. Although the unit cost of manufacturing and mounting of a terminal plate is low, the total cost inevitably rises because of the large number of terminal plates.

### SUMMARY OF THE INVENTION

An object of the present invention is to provide a wireless communication unit allowing a shield against a high-frequency noise emanating from a high-frequency circuit block and a shield for insulating the high-frequency circuit block electromagnetically to be realized at extremely low cost.

To achieve the above object, according to one aspect of the present invention, a wireless communication unit comprises a printed wiring board having a high-frequency circuit block formed thereon and a casing enclosing the printed wiring board, wherein the casing comprises a conductive casing portion and a nonconductive casing portion, a ground terminal portion that is brought into contact with a ground land arranged on the printed wiring board is formed on the conductive casing portion, a pressing portion that is brought into contact with the conductive casing portion is formed on the nonconductive casing portion, and when the casing is assembled, the pressing portion presses against the conductive casing portion so that the ground terminal portion is kept in contact with the ground land.

With this structure, the ground terminal portion formed on the conductive casing portion is brought into direct contact with the ground land arranged on the printed wiring board and, thereby, the conductive casing portion functions as a shield against a high-frequency noise. Because it is not necessary to place a separate terminal plate between the conductive casing portion and the printed wiring board, it is possible to reduce the component cost and assembling cost required for the terminal plate. Furthermore, since the number of components is reduced, the weight is reduced so that the unit will be more suitable for a portable use and the reliability as a unit will be enhanced.

In addition, because the pressing portion of the nonconductive casing portion presses against the conductive casing portion so as to keep the ground terminal portion in contact with the ground land, as long as the wireless communication unit is in an assembled state, the ground land and the ground terminal portion maintain a secure contact without falling into a poor contact state.

According to another aspect of the present invention, in the wireless communication unit as described above, at least a part of a contact surface of the conductive casing portion and the nonconductive casing portion is formed as an inclined surface, and a component force acting on the inclined surface serves as a pressure required by the ground land and the ground terminal portion for making contact with each other.

With this structure, because the component force acting on the contact surface between the conductive casing portion and the nonconductive casing portion is derived as a pressure required by the ground land and the ground terminal portion for making contact with each other, a high contact pressure can be easily produced.

According to one aspect of the present invention, a wireless communication unit comprises a printed wiring board having a high-frequency circuit block formed thereon and a casing enclosing the printed wiring board, wherein the casing comprises a conductive casing portion and a nonconductive casing portion, a ground terminal portion that is brought into contact with a ground land arranged on the printed wiring board is formed on the conductive casing portion, and the ground terminal portion forms a partition wall on the printed wiring board.

With this structure, the partition wall formed by the ground terminal portion of the conductive casing portion can be substituted for an inner shield case for enclosing a part of the printed wiring board. Because the inner shield case is not used, it is possible to reduce the component and assembling costs. Furthermore, since the number of components is reduced, the weight is reduced so that the unit will be more suitable for a portable use and the reliability as a unit will be enhanced.

According to another aspect of the present invention, in the wireless communication unit as described above, the partition wall partitions the high-frequency circuit block off from other portions.

With this structure, the partition wall formed by the ground terminal portion of the conductive casing portion partitions the high-frequency circuit block off from other portions, thereby shielding a high-frequency noise emanating from the high-frequency circuit block without using an inner shield case. Because the inner shield case is not used, it is possible to reduce the component and assembling costs. Furthermore, since the number of components is reduced, the weight is reduced so that the unit will be more suitable for a portable use and the reliability as a unit will be enhanced.

According to another aspect of the present invention, in the wireless communication unit as described above, the ground terminal portions are symmetrically formed with respect to a plane both on the conductive casing portion placed on an obverse side of the printed wiring board and on the conductive casing portion placed on a reverse side of the printed wiring board.

With this structure, it is possible to securely shield the RF circuit block electromagnetically even if the RF circuit block is formed using the both sides of the printed wiring board. In addition, since the printed wiring board is held between the ground terminal portions provided on both sides, it is possible to increase a contact force of the ground terminal portions against the ground lands and, thereby secure the contact.

According to another aspect of the present invention, in the wireless communication unit as described above, an embossed portion is formed on the conductive casing portion in such a shape as being embossed toward the printed wiring board from outside, and the embossed portion is formed as the ground terminal portion.

With this structure, it is possible to form the ground terminal portion of the conductive casing portion far more easily than fitting a separate component. Moreover, it is possible, by applying projections or depressions to the conductive casing portion, to increase the strength of the conductive casing portion and, accordingly, increase the overall strength of the wireless communication unit.

According to another aspect of the present invention, in the wireless communication unit as described above, the embossed portion is formed by press molding.

With this structure, the conductive casing portion can be produced in volume efficiently.

According to another aspect of the present invention, in the wireless communication unit as described above, a portion enclosed by the conductive casing portion is inserted into electronic equipment.

With this structure, it is possible to alleviate the effects of the noise afflicting each other between the electronic equipment and the wireless communication unit.

According to another aspect of the present invention, in the wireless communication unit as described above, an antenna element is provided in an area which is not enclosed by the conductive casing portion but enclosed by the nonconductive portion.

With this structure, because the antenna element is located outside the conductive casing portion, it is possible to transmit and receive the radio waves to and from outside without trouble. At the same time, because the antenna element is enclosed with the nonconductive casing portion, a full protection is provided thereto.

As described, the wireless communication unit of the present invention is constructed in such a way that the casing for enclosing the printed wiring board having the high-frequency circuit block formed thereon is comprised of the conductive casing portion and the nonconductive casing portion; the ground terminal portion that is brought into contact with the ground land arranged on the printed wiring board is formed on the conductive casing portion; the pressing portion that comes in contact with the conductive casing portion is formed on the nonconductive casing portion; and, when the casing is assembled, the pressing portion presses against the conductive casing portion so as to keep the ground terminal portion in contact with the ground land. Since the ground terminal portion is brought into direct contact with the ground land, the conductive casing portion functions as a shield against a high-frequency noise. Therefore, it is not necessary to place a separate terminal plate between the conductive casing portion and the printed wiring board, and it is possible to reduce the component and assembling costs. Because the number of components is reduced, the weight is reduced so that the unit will be more suitable for a portable use and the reliability as a unit will be enhanced.

Furthermore, the wireless communication unit of the present invention is constructed in such a way that the casing for enclosing the printed wiring board having the high-frequency circuit block formed thereon is comprised of the conductive casing portion and the nonconductive casing portion; the ground terminal portion that is brought into contact with the ground land arranged on the printed wiring board is formed on the conductive casing portion; and the ground terminal portion forms the partition wall on the printed wiring board. Because the partition wall formed by the ground terminal portion of the conductive casing portion is used to enclose a part of the printed wiring board and can be used as a substitute replacing the inner shield case, it is possible to reduce the component and assembling costs which are otherwise required for the inner shield case. In addition, the reduced number of components contributes to reducing the weight so that the unit will be more suitable for a portable use and the reliability as a unit will be enhanced.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a cross sectional view of a wireless LAN communication card of a first embodiment of the invention;

FIG. 2 is an exploded perspective view of the wireless LAN communication card of the first embodiment;

FIG. 3 is a partial cross sectional view in perspective of the wireless LAN communication card of the first embodiment;

FIG. 4 is a partial cross sectional view of the wireless LAN communication card of the first embodiment;

FIG. 5 is a partial cross sectional view in perspective of a wireless LAN communication card of a second embodiment of the invention;

FIG. 6 is a partial cross sectional view of a wireless LAN communication card of a third embodiment of the invention;

FIG. 7 is a diagram for explaining the mechanical action;

FIG. 8 is a perspective view of a notebook PC;

FIG. 9 is an exploded perspective view of a conventional wireless LAN communication card;

FIG. 10 is a partial cross sectional view showing another structural example of the conventional wireless LAN communication card;

FIG. 11 is a partial perspective view of the wireless LAN communication card shown in FIG. 9;

FIG. 12 is a partial perspective view showing another structural example of the conventional wireless LAN communication card; and

FIG. 13 is a partial perspective view showing another structural example of the conventional wireless LAN communication card.

### DESCRIPTION OF THE PREFERRED EMBODIMENTS

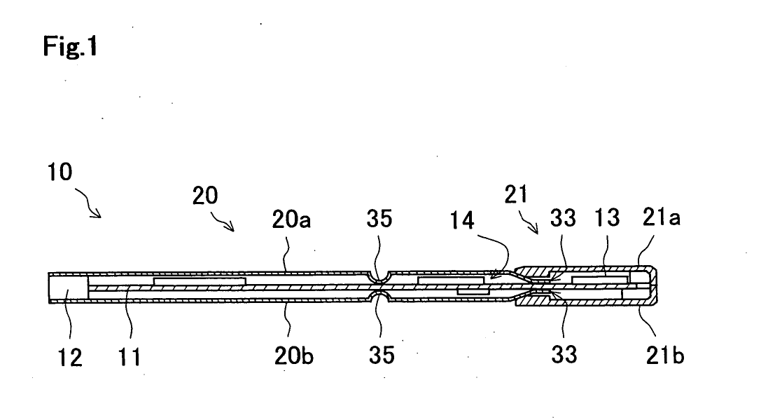

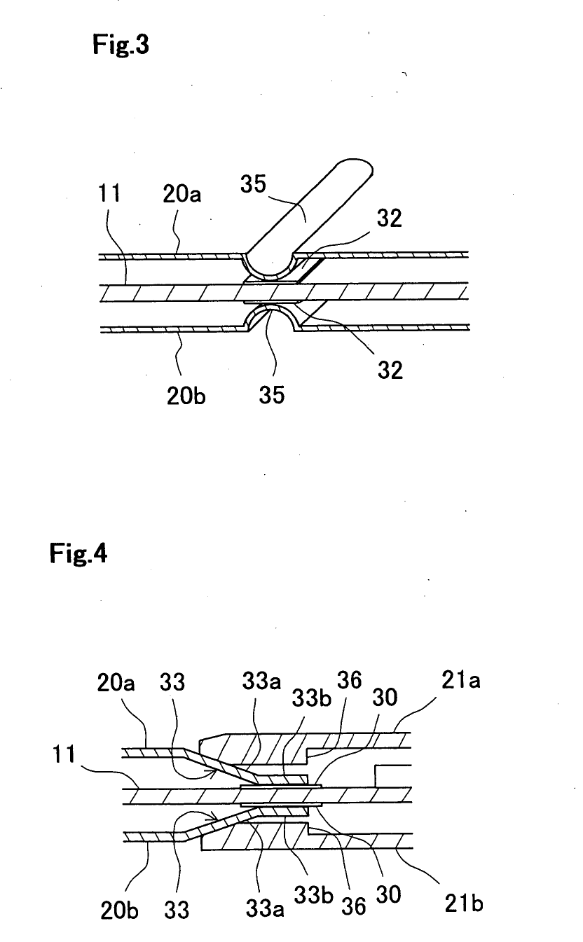

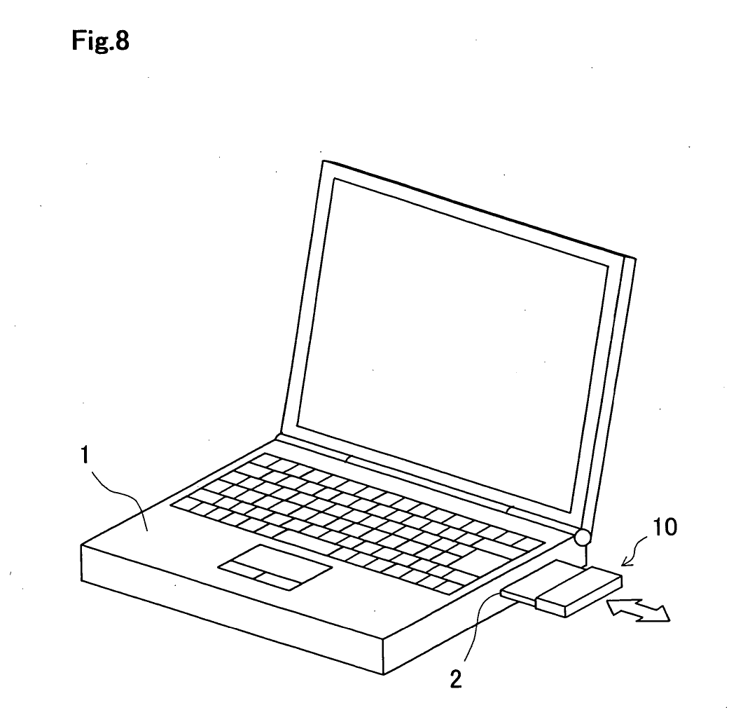

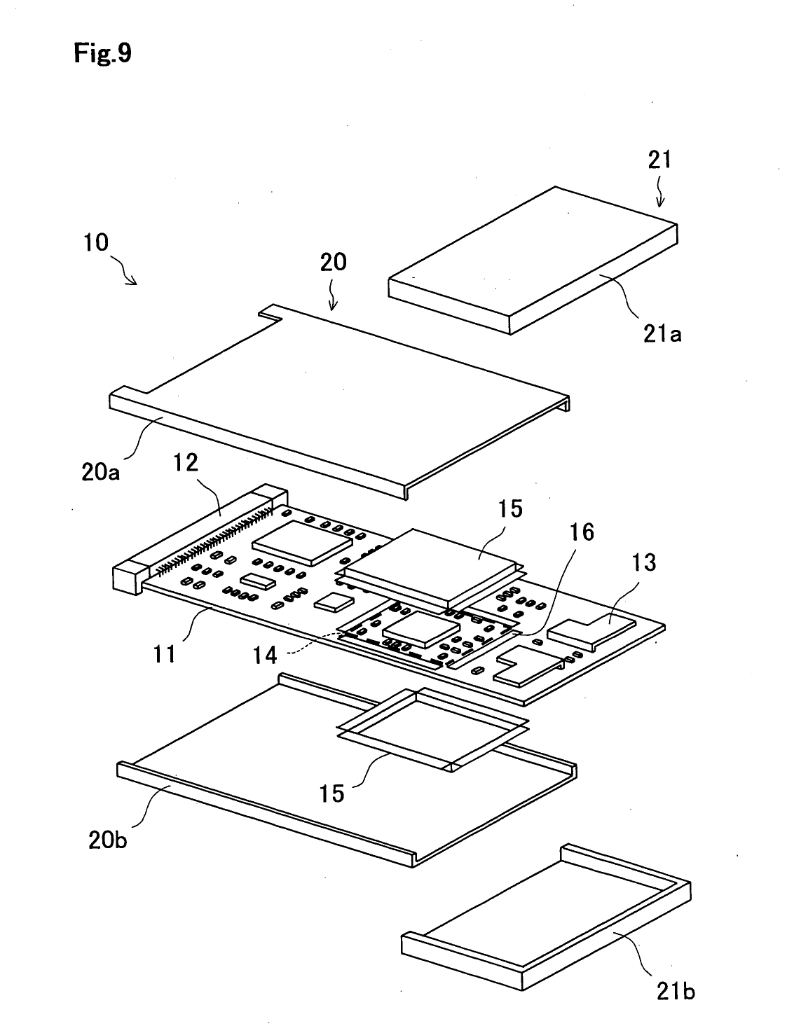

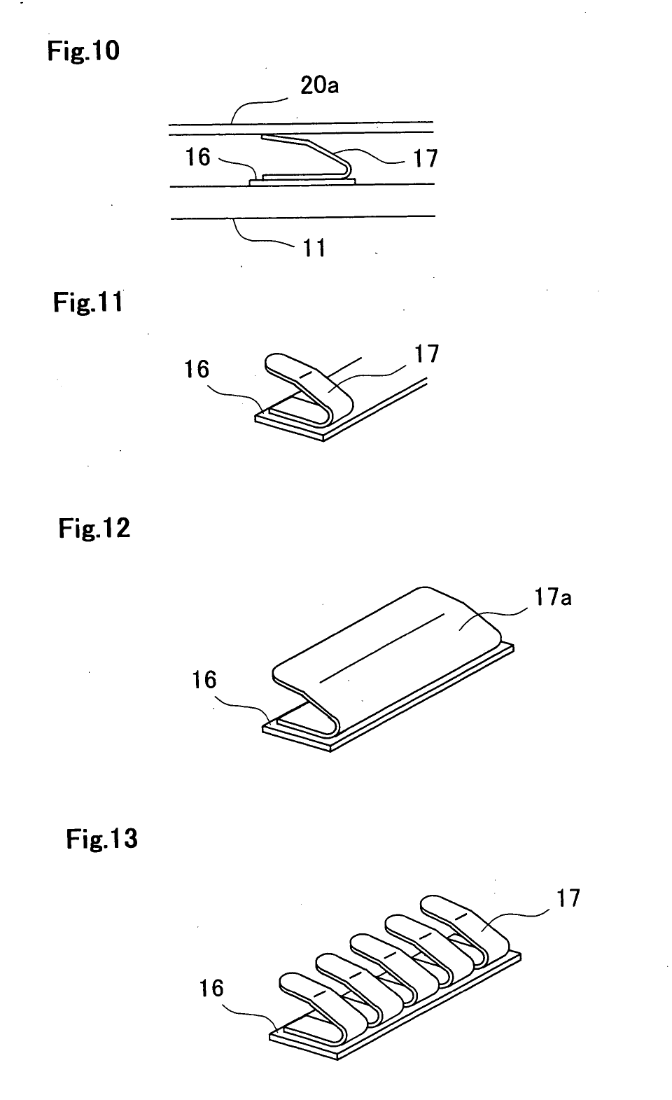

Hereinafter, a first embodiment of the present invention will be described with reference to FIGS. 1 to 4. Here, a wireless LAN communication card of the first embodiment has structures common in many portions with the conventional structures shown in FIGS. 8 and 9. For this reason, in the following descriptions, such components as are found also in the descriptions with reference to FIGS. 8 and 9 are identified with the same reference numerals and descriptions thereof will not be repeated.

In a wireless LAN communication card 10 of the first embodiment, ground lands are provided on a surface of a printed wiring board 11 so as to surround an RF circuit block 14, i.e., a high-frequency circuit block. One side of the RF circuit block 14, which is rectangular in plan view, is formed by an edge of the printed wiring board 11, and three linearly-shaped ground lands are laid so as to face the remaining three sides respectively. The three ground lands are namely, a ground land 30 laid so as to separate an antenna element 13 and the RF circuit block 14 from each other, a ground land 31 laid so as to be perpendicular to the ground land 30, and a ground land 32 laid near the center of the printed wiring board 11 so as to be parallel to the ground land 30. The ground land 30 is divided midway therethrough, and wiring patterns of the antenna element 13 are routed through the divided area.

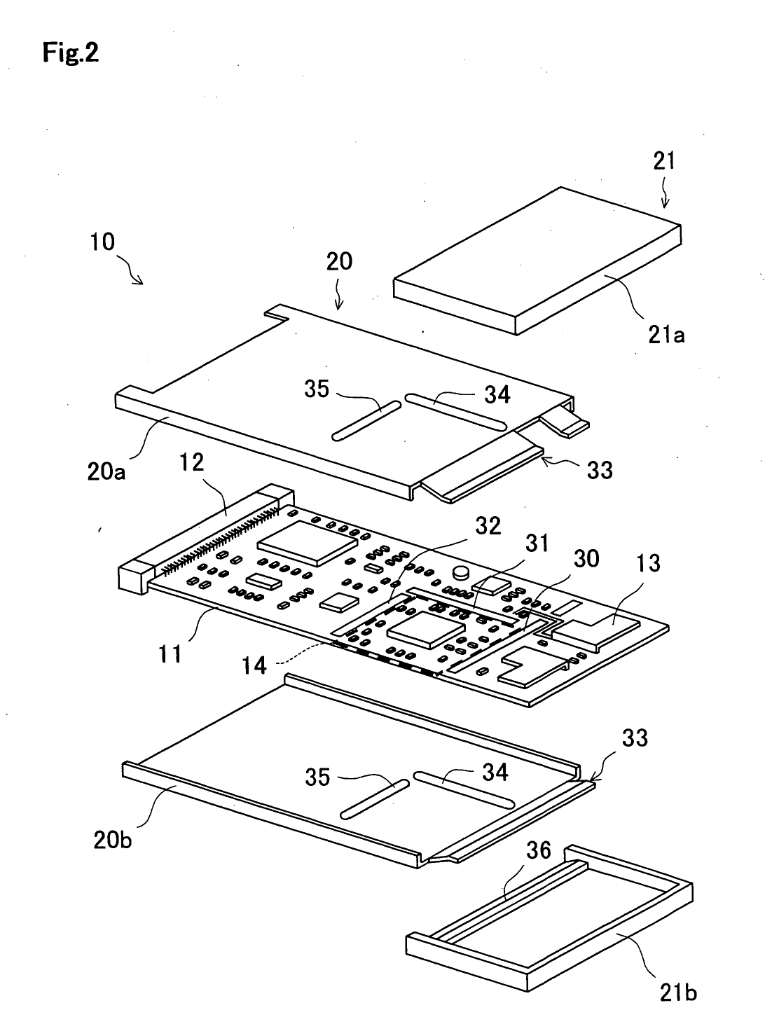

The ground lands 30, 31, and 32 are formed by printed patterns. The RF circuit block 14 is formed by using both sides of the printed wiring board 11, and also a group of ground lands identically formed with ground lands 30, 31, and 32 on an obverse side of the printed wiring board 11 is laid on a reverse side thereof (hidden side in FIG. 2), and both groups of ground lands assume symmetrical positions with respect to the plane of the printed wiring board 11.

A ground terminal portion 33 that comes in contact with the ground land 30 is formed integrally with a metallic shell 20a of a conductive casing portion 20 at one end thereof. The ground terminal portion 33 comprises an inclined portion 33a extending in a slanting direction from the shell 20a and a contact portion 33b formed at a leading edge of the inclined portion 33a so as to be laid in parallel to the obverse side of the printed wiring board 11 (see FIG. 4). A similar ground terminal portion 33 is also formed at one end of a shell 20b.

The ground terminal portions 33 are slightly different from each other between the shells 20a and 20b. Specifically, because the ground land 30 on the obverse side of the printed wiring board 11 has a divided shape, the ground terminal portion 33 of the shell 20a has a matching divided shape. Because the ground land 30 on the reverse side of the printed wiring board 11 does not have a divided shape, the ground terminal portion 33 of the shell 20b has a continuous shape all the way through.

The shell 20a is provided with a ground terminal portion 34 that corresponds to the ground land 31 and a ground terminal portion 35 that corresponds to the ground land 32. The ground terminal portions 34 and 35 are groove-shaped embossed portions having substantially a semicircular cross section formed by being embossed from outside of the shell 20a toward the printed wiring board 11. These embossed portions are formed by press molding. Ground terminal portions 34 and 35 in the similar structure are also provided on the shell 20b.

Similar to the ground lands 30, 31, and 32 on both sides of the printed wiring board 11 symmetrically arranged with respect to the plane of the board, the ground terminal portions 33, 34, and 35 on the shells 20a and 20b are also symmetrically arranged with respect to the plane of the printed wiring board 11.

The ground terminal portions 33, 34, and 35 have predetermined lengths respectively and form partition walls on the printed wiring board 11.

The shells 21a and 21b, made of synthetic resin, of the nonconductive casing portion 21 are provided, on individual inner surfaces thereof that face each other, with pressing portions 36 that come in contact with and press against the shells 20a and 20b of the conductive casing portion 20. The pressing portion 36 touches the inclined portion 33a of the ground terminal portion 33.

Described below is how the wireless LAN communication card 10 is assembled. First, the printed wiring board 11 is completed. Then, this printed wiring board 11 is sandwiched between the shells 20a and 20b which are fitted to each other and firmly fixed so as to complete the conductive casing portion 20. The conductive casing portion 20 is fixed with respect to the printed wiring board 11. The conductive casing portion 20 encloses the RF circuit block 14, but does not enclose the antenna element 13.

Once the conductive casing portion 20 is completed, the ground terminal portions 33, 34, and 35 are brought into contact with the ground lands 30, 31, and 32 respectively. The ground terminal portions 33, due to the resiliency of the metallic material of shells 20a and 20b, touch the ground lands 30 elastically.

The ground terminal portions 33, 34, and 35 kept in contact with the ground lands 33, 34, and 35 form partition walls that surround the RF circuit block 14. Consequently, it is possible to partition the RF circuit block 14 off from other portions without using an inner shield case and block the high-frequency noise emanating from the RF circuit block 14.

Thereafter, the end portion of the printed wiring board 11 is held between the shells 21a and 21b which are, then, fitted to each other and firmly fixed so as to complete the nonconductive casing portion 21. The nonconductive casing portion 21 encloses and protects the antenna element 13.

Once the nonconductive casing portion is formed, the pressing portions 36 push against the inclined portions 33a. The conductive casing portion 20 and nonconductive casing portion 21 are fixed to the printed wiring board 11 so as not to be separated toward left and right directions viewed in FIG. 4. For this reason, component forces acting on the inclined face are caused between the inclined portion 33a and the pressing portion 36.

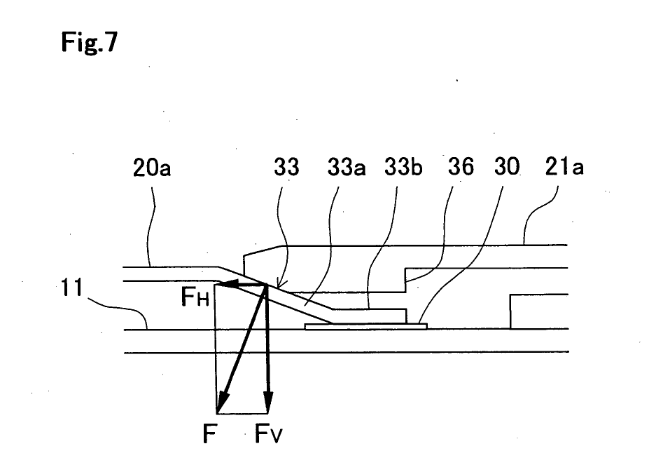

As shown in a diagram for explaining the mechanical action in FIG. 7, a contact pressure F exerted by the shell 21a on the inclined portion 33a is decomposed into a horizontal component F_{H} of the force acting on the inclined face and, at the same time, a vertical component F_{V} of the force acting on the inclined face. The contact portion 33b is strongly pressed against the ground land 30 by the vertical component F_{V} of the force acting on the inclined face. With respect to the shell 21b, in a similar manner, the contact portion 33b is strongly pressed against the ground land 30 by the vertical component F_{V} of the force acting on the inclined face. By this step, the wireless LAN communication card 10 is completed. The completed wireless LAN communication card 10 can be used after being inserted into the card slot 2 of the PC 1 as shown in FIG. 7.

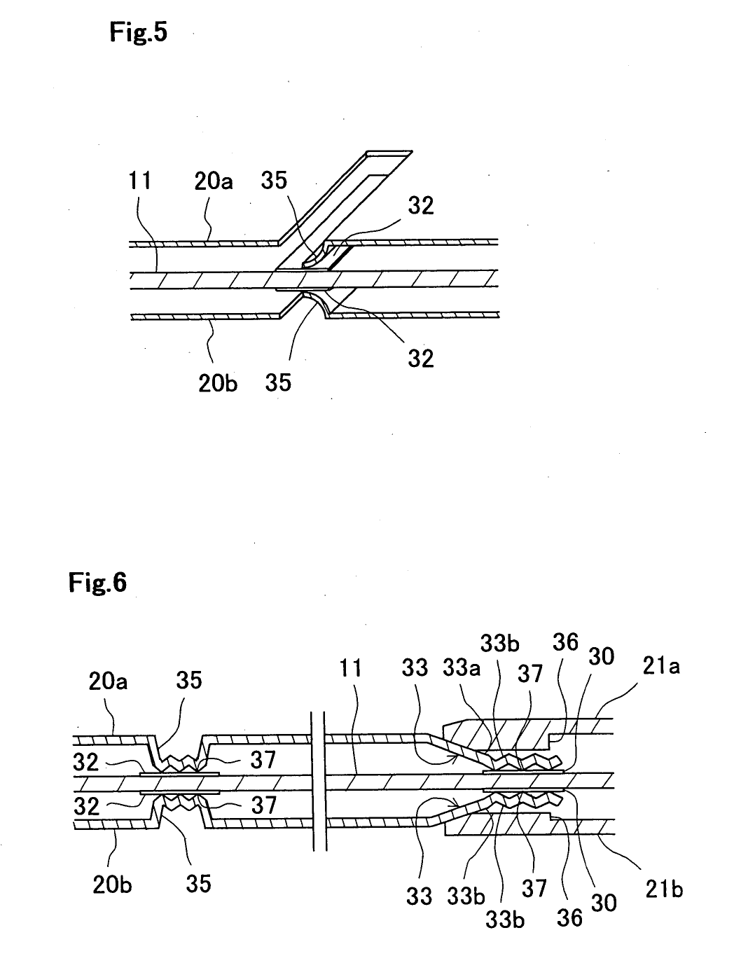

A wireless communication unit of a second embodiment of the invention is shown in FIG. 5. In the second embodiment, the ground terminal portions 35 are formed by tongue pieces raised out of the precut parts of the shells 20a and 20b of the conductive casing portion 20 after making cuttings. The ground terminal portions 34 are also formed by tongue pieces arranged in the same manner. According to this structure, as applied to the ground terminal portions 33, the ground terminal portions 34 and 35 can also be brought into elastic contacts with the ground lands 31 and 32 because of the resiliency possessed by the metallic material of the shells 20a and 20b.

A wireless communication unit of a third embodiment of the invention is shown in FIG. 6. In the third embodiment, the basic shape of the ground terminal portions 34 and 35 are the same groove-shaped embossed portions as in the first embodiment. However, sharp minute teeth 37 are formed at the bottom of the embossed portions. Similarly, the minute teeth 37 are also formed on the contact portions 33b of the ground terminal portions 33. The minute teeth 37 bite into the ground lands 30, 31, and 32, thereby securing the electrical connections between the ground terminal portions 33, 34, and 35, and the ground lands 30, 31, and 32 for added reliability.

It is to be noted that the present invention is not limited to the wireless LAN communication card, but may be applied to a wireless communication unit that takes a shape other than a card, for example, a PDA (Personal Digital Assistant) and the like.

Obviously, many modifications and variations of the present invention are possible in light of the above teachings. It is therefore to be understood that the present invention is not limited to the embodiments as described above and that within the scope of the appended claims, the invention may be practiced other than as specifically described.

1. A wireless communication unit comprising:
a printed wiring board having a high-frequency circuit block formed thereon; and
a casing enclosing the printed wiring board,
wherein the casing comprises a conductive casing portion and a nonconductive casing portion,
a ground terminal portion that is brought into contact with a ground land arranged on the printed wiring board is formed on the conductive casing portion,
a pressing portion that is brought into contact with the conductive casing portion is formed on the nonconductive casing portion, and
when the casing is assembled, the pressing portion presses against the conductive casing portion so that the ground terminal portion is kept in contact with the ground land.

2. A wireless communication unit as claimed in claim 1,
wherein at least a part of a contact surface of the conductive casing portion and the nonconductive casing portion is formed as an inclined surface, and
a component force acting on the inclined surface serves as a pressure required by the ground land and the ground terminal portion for making contact with each other.

3. A wireless communication unit comprising:
a printed wiring board having a high-frequency circuit block formed thereon; and
a casing enclosing the printed wiring board,
wherein the casing comprises a conductive casing portion and a nonconductive casing portion,
a ground terminal portion that is brought into contact with a ground land arranged on the printed wiring board is formed on the conductive casing portion, and
the ground terminal portion forms a partition wall on the printed wiring board.

4. A wireless communication unit as claimed in claim 3,
wherein the partition wall partitions the high-frequency circuit block off from other portions.

5. A wireless communication unit as claimed in claim 3,
wherein the ground terminal portions are symmetrically formed with respect to a plane both on the conductive casing portion placed on an obverse side of the printed wiring board and on the conductive casing portion placed on a reverse side of the printed wiring board.

6. A wireless communication unit as claimed in claim 1,
wherein an embossed portion is formed on the conductive casing portion in such a shape as being embossed toward the printed wiring board from outside, and
the embossed portion is formed as the ground terminal portion.

7. A wireless communication unit as claimed in claim 3,
wherein an embossed portion is formed on the conductive casing portion in such a shape as being embossed toward the printed wiring board from outside, and
the embossed portion is formed as the ground terminal portion.

8. A wireless communication unit as claimed in claim 6,
wherein the embossed portion is formed by press molding.

9. A wireless communication unit as claimed in claim 7,
wherein the embossed portion is formed by press molding.

10. A wireless communication unit as claimed in claim 1,
wherein a portion enclosed by the conductive casing portion is inserted into electronic equipment.

11. A wireless communication unit as claimed in claim 3,
wherein a portion enclosed by the conductive casing portion is inserted into electronic equipment.

12. A wireless communication unit as claimed in claim 1,
wherein an antenna element is provided in an area which is not enclosed by the conductive casing portion but enclosed by the nonconductive portion.

13. A wireless communication unit as claimed in claim 3,
wherein an antenna element is provided in an area which is not enclosed by the conductive casing portion but enclosed by the nonconductive portion.
